(19) United States
(12) Patent Application Publication
(10) Pub. No.: US 2012/0038727 A1
(43) Pub. Date: Feb. 16, 2012

(54) INKJET PRINTER AND INK EJECTING METHOD

(75) Inventors: Yasushi Kuribayashi, Shizuoka-ken (JP); Kazuhiro Hara, Shizuoka-ken (JP); Hiroshi Murata, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/205,958

(22) Filed: Aug. 9, 2011

Related U.S. Application Data
(60) Provisional application No. 61/372,666, filed on Aug. 11, 2010.

(51) Int. Cl. B41J 2/01

(52) U.S. Cl. 347/104

(57) ABSTRACT

According to one embodiment, the inkjet printer includes an endless device which has a circumferential surface for adsorbing a sheet, an inkjet head for ejecting ink, a tray, and a controller. The tray is moved from a home position toward the inkjet head along a circumferential surface of the endless device, using the tray moving mechanism. The tray is inserted to a clearance between the circumferential surface of the endless device and the inkjet head. The inkjet head ejects ink toward the tray if the tray moves to a position facing the inkjet head.

### CROSS-REFERENCE TO RELATED APPLICATIONS

This application is based upon and claims the benefit of priority from: U.S. Provisional Application No. 61/372,666 filed on Aug. 11, 2010, the entire contents of each of which are incorporated herein reference.

### FIELD

Embodiments described herein relate generally to an inkjet printer and an ink ejecting method for preventing nozzles from clogging.

### BACKGROUND

An inkjet printer includes an endless device which is configured by a rotating drum or belt, and inkjet heads which are arranged along a circumferential surface of the endless device.

In inkjet printers in the related art, an ink ejecting operation was performed periodically or at a predetermined time, in order to prevent the nozzles of the inkjet head from clogging. Since a head is relatively fixed to an endless device of a line head-type printer, there is no standby position for the inkjet head. For this reason, there is a problem in the line head-type printer that the endless device, paper sheets, or the like, may be contaminated by ejected ink when ink is ejected from the inkjet head in order to prevent clogging of the nozzle. In order to solve this problem, there is disclosed an inkjet printer in which a recessed portion for receiving waste ink is formed on a part of the circumferential surface of the endless device of a drum or the like. In the inkjet printer, the ink ejected from the inkjet head is received in the recessed portion. However, when such a recessed portion is formed on the circumferential surface of the endless device, there is a limit on the position for holding sheets, since a part of the circumferential surface of the endless device become discontinuous.

### BRIEF DESCRIPTION OF THE DRAWINGS

FIG. 1 is a side view for schematically showing an inside of an inkjet printer according to a first embodiment;

FIG. 2 is a perspective view for showing an endless device, a head unit of the inkjet printer shown in FIG. 1;

FIG. 3 is a side view showing a state where the head unit of the inkjet printer shown in FIG. 1 moves in a direction away from the endless device;

FIG. 4 is a side view showing a state where a tray of the inkjet printer shown in FIG. 1 moves in a direction toward the head unit;

FIG. 5 is a side view which shows a state where the tray of the inkjet printer shown in FIG. 1 is moved to a position beyond a cleaning mechanism;

FIG. 6 is a block diagram which shows a configuration of a controller of the inkjet printer shown in FIG. 1;

FIG. 7 is a flow chart which shows an ejecting sequence of ink which is performed by the controller of the inkjet printer shown in FIG. 1;

FIG. 8 is a side view which shows a part of an inkjet printer according to a second embodiment;

FIG. 9 is a side view which shows a part of an inkjet printer according to a third embodiment; and

FIG. 10 is a side view which schematically shows an inkjet printer according to a fourth embodiment.

### DETAILED DESCRIPTION

In general, according to one embodiment, an inkjet printer includes an endless device, inkjet heads, a tray, a tray moving mechanism, and a controller. The endless device is configured by a drum or a belt, has a circumferential surface which adsorbs a sheet, and rotates in a predetermined direction. The inkjet head is arranged to face the circumferential surface of the endless device, and defines a clearance between the inkjet head and the circumferential surface. The tray is moved in a circumferential direction of the endless device along the circumferential surface of the endless device. The tray can move in the clearances, which is between a position where the tray faces the inkjet head and a position where the tray does not face the inkjet head. The tray moving mechanism moves the tray in the circumferential direction, independently from the endless device. The controller allows the inkjet head to eject ink, if the tray moves to a position corresponding to the inkjet head.

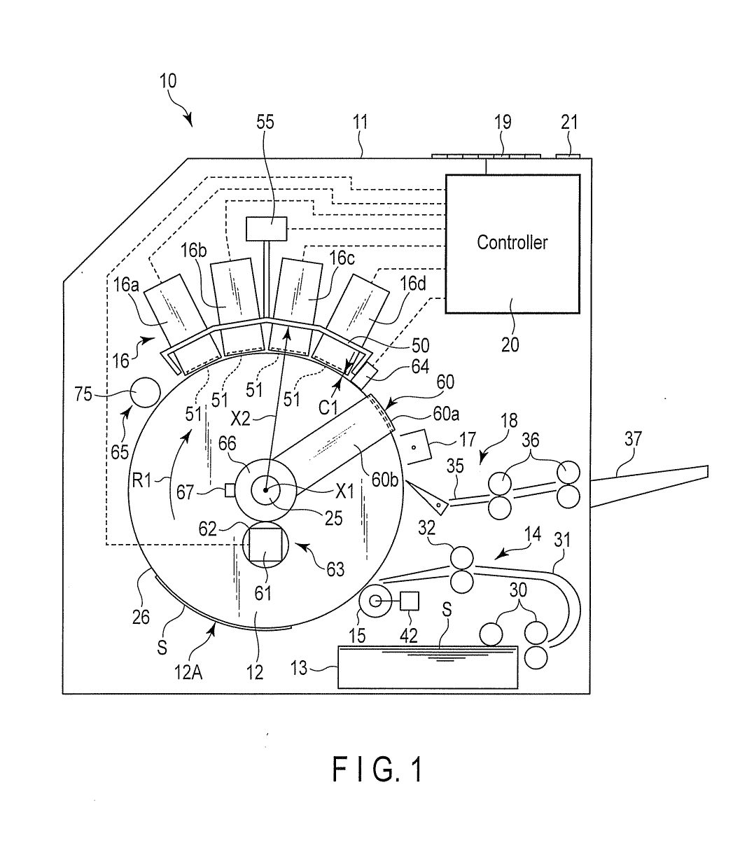

Hereinafter, an inkjet printer according to a first embodiment will be described with reference to FIGS. 1 to 7.

FIG. 1 shows an inkjet printer 10. The inkjet printer 10 includes a housing 11, an endless device 12A configured by a drum 12 which is accommodated in the housing 11, a sheet receiving unit 13, a sheet feeding mechanism 14, a charging roller 15, a head unit 16, a neutralizing charger 17, a sheet discharging mechanism 18, an operation unit 19 which functions as a display unit, a controller 20, a power switch 21, and the like.

The endless device 12A configured by the drum 12 rotates at a constant circumferential velocity in a direction which is shown by an arrow R1, around a rotation axis 25 by a rotation mechanism (not shown). A dielectric layer is provided on a circumferential surface 26 of the drum 12.

The sheet receiving unit 13 accommodates a plurality of sheets S such as papers for example as a recording medium. The sheet feeding mechanism 14 includes a sheet feeding roller 30, a sheet transporting path 31, and a transporting roller 32. The charging roller 15 is arranged to face the circumferential surface 26 of the drum 12. A DC power circuit 42 is connected to the charging roller 15. When a DC voltage is applied to the charging roller 15 by the DC power circuit 42, an electric charge is generated for electro-statically adsorbing the sheet S, on the circumferential surface 26 of the drum 12.

The endless device 12A according to the embodiment has a configuration in which the sheet S is adsorbed by electrostatic adsorption. However, as other embodiments, an endless device which adsorbs the sheet S using negative pressure may be adopted. In such a case, a negative pressure chamber is formed inside the endless device, and the sheet is adsorbed onto the circumferential surface of the endless device by the negative pressure which is generated in the negative pressure chamber.

The sheet S which is adsorbed to the circumferential surface 26 of the drum 12 is transported to the head unit 16. A position of in a rotation direction of the drum 12 is detected by a rotation angle sensor (not shown) of an encoder, or the like. The sheet discharging mechanism 18 includes a transporting guide 35, a sheet discharging roller 36, sheet discharging tray 37, and the like.

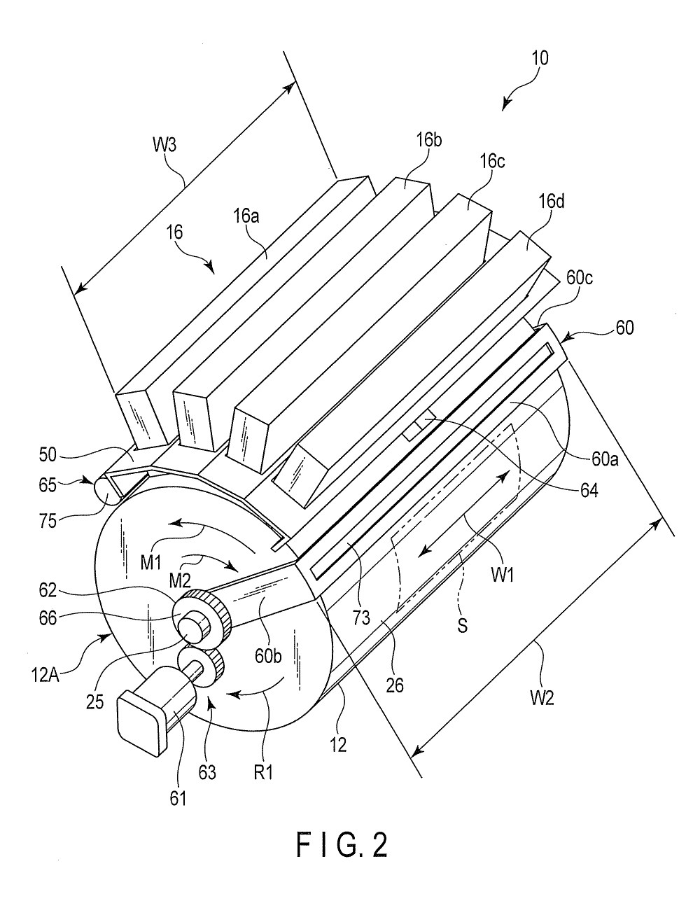

FIG. 2 is a perspective view which shows the endless device 12A which is configured by the drum 12 and the head unit 16. The head unit 16 includes inkjet heads for each color 16a, 16b, 16c, and 16d, which are capable of color printing. All of these inkjet heads 16a, 16b, 16c, and 16d, are line heads which are extended in a width direction (a direction shown by an arrow W1, in FIG. 2) of the sheet S. They are attached to a frame 50, respectively. The inkjet heads 16a, 16b, 16c, and 16d have a nozzle plate 51 (shown in FIG. 1) which includes a plurality of nozzle holes for ejecting ink.

An example of the inkjet heads 16a, 16b, 16c, and 16d includes a piezoelectric element as a driving member. Ink is ejected from nozzle holes of the nozzle plate 51 when the piezoelectric element is deformed by applying a voltage to the piezoelectric element and by adding pressure to the ink. In addition, as another example of the driving member, a heating element may be adopted. When the ink is heated by the heating element, the ink is ejected from the nozzle holes by the pressure of foam which is generated due to the evaporation of the ink.

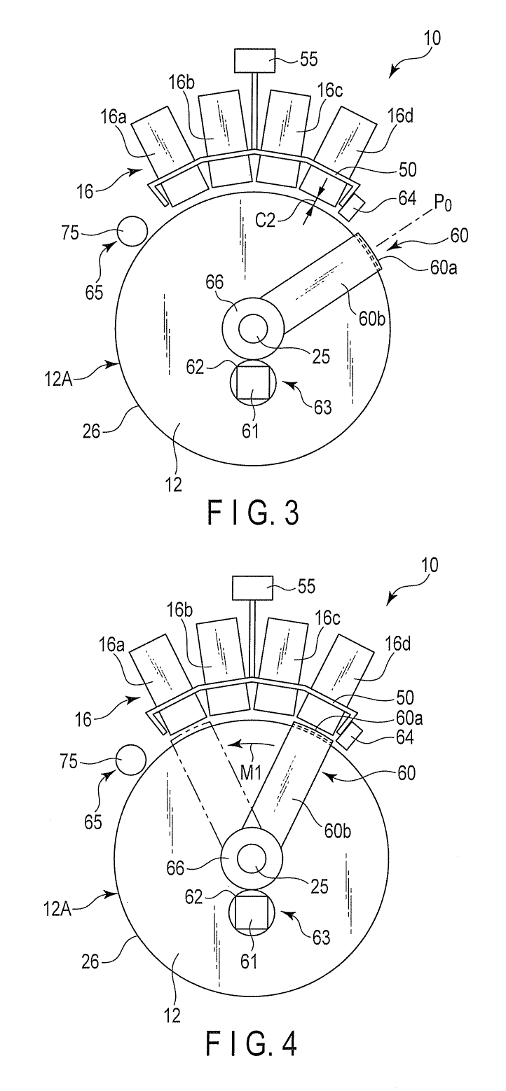

The frame 50 which holds the inkjet heads 16a, 16b, 16c, and 16d can change a distance X2 from a rotation center X1 of the drum 12(shown in FIG. 1) by a head moving actuator 55. That is, the frame 50 can be moved between a reference position shown in FIG. 1 and a retreat position shown in FIG. 3, by the head moving actuator 55. Here, the “reference position” is a position where a first clearance C1 which is suitable for image forming, is defined between the drum 12 and the inkjet heads 16a, 16b, 16c, and 16d, when the head unit 16 gets closer to the drum 12. The “retreat position” is a position where a second clearance C2 which is larger than the first clearance C1, is defined between the drum 12 and the inkjet heads 16a, 16b, 16c, and 16d, when the head unit 16 is separated from the drum 12.

The inkjet printer 10 according to the embodiment includes a tray 60, a tray moving mechanism 63 which has a tray moving motor 61 for rotating the tray 60 and a power transmitting unit 62, a sensor 64 for detecting the tray 60, and a cleaning mechanism 65. As shown in

FIG. 2, the tray 60 has an ink receiving unit 60a which extends in an axial direction of the rotation axis 25 of the drum 12, and a pair of arms 60b and 60c which extends along both side surfaces of the drum 12. The tray 60 can rotate in a direction shown by arrows Ml and M2, around a rotation axis 66 having the same center as that of the rotation axis 25. The arms 60b and 60c extend in a radial direction of the drum 12 toward the rotation axis 25 from both ends of the ink receiving unit 60a.

A width W2 of the ink receiving unit 60a (shown in FIG. 2) is larger than a width W3 in an ink ejection region of the inkjet heads 16a, 16b, 16c, and 16d, such that ink ejected from the inkjet heads 16a, 16b, 16c, and 16d can be received. A recessed portion 73 which can receive ink ejected from the inkjet heads 16a, 16b, 16c, and 16d, is formed in the ink receiving unit 60a of the tray 60.

The cleaning mechanism 65 has a wiping member 75 which wipes away ink attached to the tray 60. The wiping member 75 has the same width as that of the width W2 (shown in FIG. 2) of the ink receiving unit 60a. The ink attached to the tray 60 is removed from the tray 60 when the tray 60 comes into contact with the wiping member 75.

FIG. 1 shows a state where the head unit 16 is positioned at the reference position, and the first clearance C1 for forming images is defined between the inkjet heads 16a, 16b, 16c, and 16d and the drum 12. FIG. 3 shows a state where the second clearance C2 for inserting the tray 60, is defined between the drum 12 and the inkjet heads 16a, 16b, 16c, and 16d, by moving the head unit 16 to the retreat position.

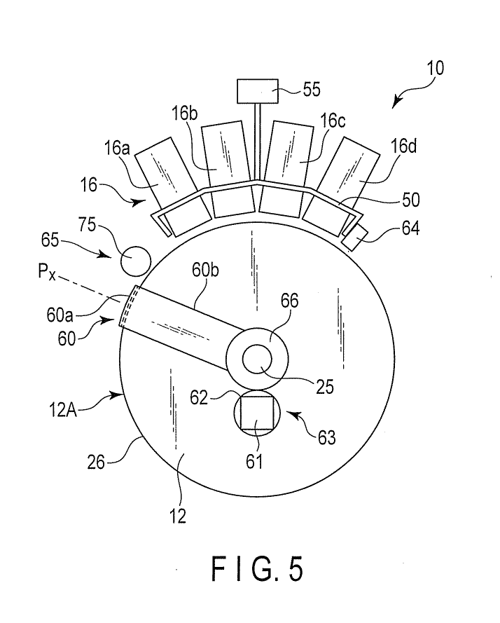

FIG. 4 is a side view showing a state where the tray 60 is moved toward the head unit 16. FIG. 5 shows a state where the tray 60 is moved to a turning position Pₓ beyond the cleaning mechanism 65. In this manner, the tray 60 can rotate around the rotation axis 25 to the turning position Pₓ shown in FIG. 5 through an intermediate position shown in FIG. 4, from the home position pₒ shown in FIG. 3 independently from the drum 12. In addition, it is possible to return to the home position pₒ) shown in FIG. 3 from the turning position Pₓ shown in FIG. 5.

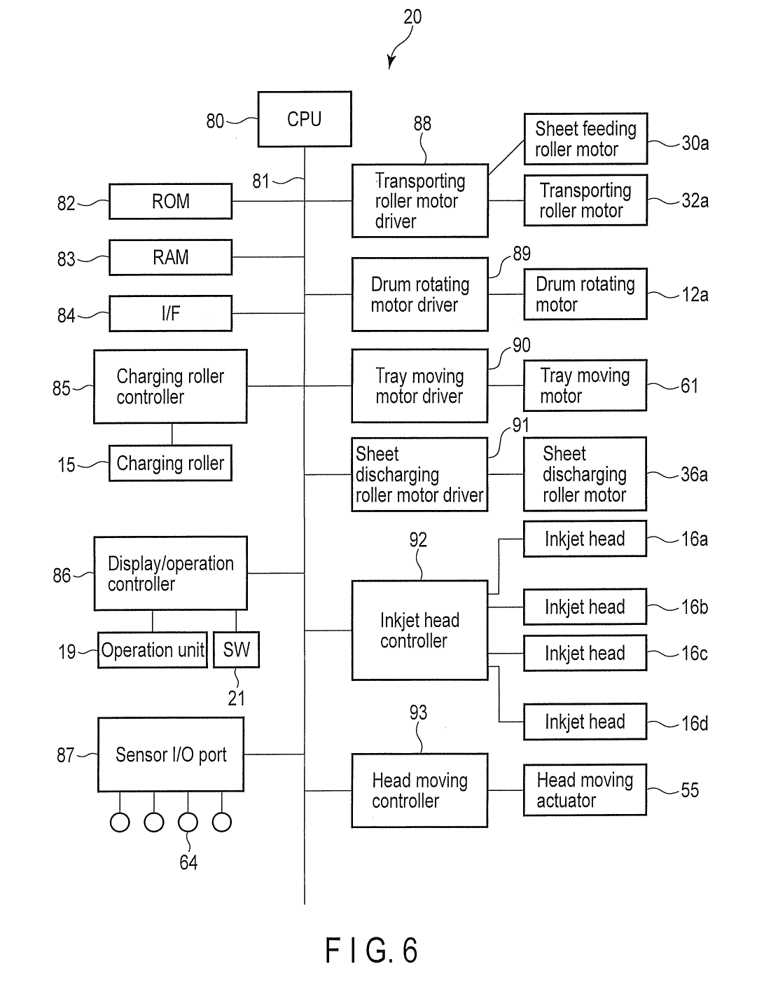

FIG. 6 is a block diagram showing a configuration of the controller 20 of the inkjet printer 10 according to the embodiment. The controller 20 includes a CPU (Central Processing Unit) 80 which functions as a processor. The CPU 80 is connected with a ROM (Read Only Memory) 82, a RAM (Random Access Memory) 83, a communication interface 84, a controller 85 for the charging roller, a controller 86 for display and operation, a sensor input and output port 87, a driver 88 for the transport roller motor, a driver 89 for the drum rotating motor, a driver 90 for the tray moving motor, a driver 91 for the paper discharging roller motor, a controller 92 for the inkjet head, and a controller 93 for moving the head, through a bus line 81.

A program for controlling the CPU 80 or various fixed data is stored in the ROM 82. Various memory areas for storing various data which is necessary for image forming, are formed in the RAM 83. The communication interface unit 84 controls data communication which is performed between the interface unit and external devices, through a communication line. The controller 85 for the charging roller controls DC voltage supplied to the charging roller 15. The controller 86 for display and operation controls the operation unit 19 which serves as a display unit having a touch panel, as well. It is possible to store information which is necessary for image forming, in the RAM 83, by controlling the operation unit 19. The sensor input and output port 87 is connected to various sensors (for example, the sensor 64).

The driver 88 for the transport roller motor drives a motor 30a for the sheet feeding roller 30 and a motor 32a for the transport roller 32. The driver 89 for the drum rotation motor drives a motor 12a for driving the drum 12. The driver 90 for the tray moving motor drives a motor 61 for moving the tray. The driver 91 for the sheet discharging roller motor drives a motor 36a for rotating the sheet discharging roller 36. The controller 92 for the inkjet head controls an ink ejecting operation of the inkjet heads 16a, 16b, 16c, and 16d. The controller 93 for moving heads drives the actuator 55 for moving heads.

Hereinafter, an outline of the image forming processing by the inkjet printer 10 according to the embodiment will be described with reference to FIG. 1. The sheet S accommodated in the sheet receiving unit 13 is transported toward the charging roller 15 by the sheet feeding mechanism 14. The sheet S is supplied between the circumferential surface 26 of the drum 12 and the charging roller 15. A DC voltage is applied to the charging roller 15 by the DC power circuit 42. For this reason, an electric charge with a first polarity is charged to the sheet S, and an electric charge with a second polarity is charged to a dielectric of the drum 12. Due to the charges, the sheet S is electro statically adsorbed to the drum 12.

The sheet S which is adsorbed to the circumferential surface 26 of the drum 12 is moved in a rotation direction R1. In a case of color printing, when the sheet S reaches the first inkjet head 16a, a first color ink is ejected to the sheet S from the first inkjet head 16a. The sheet S is rotated while being adsorbed to the drum 12 and reaches the second inkjet head 16b. By doing this, a second color ink is ejected to the sheet S from the second inkjet head 16b. Further, when the drum 12 rotates, a third color ink is ejected to the sheet S from the third inkjet head 16c. Further, when the drum rotates, a fourth color ink is ejected to the sheet S from the fourth inkjet head 16d. In this manner, an image is formed on the sheet S while the drum 12 is rotating. That is, the inkjet printer 10 performs color printing by a multi pass system with a line head type.

When forming images, the head unit 16 is moved to the reference position shown in FIG. 1 by the head moving actuator 55. For this reason, the first clearance C1 which is suitable for image forming is defined between the sheet S and the nozzle plate 51 of the inkjet heads 16a, 16b, 16c, and 16d. For this reason, it is possible to suppress an influence on the ejection of ink caused by an air flow which is accompanied by the rotation of the drum 12, and to form a desired image with high quality.

An AC voltage is applied to the sheet S printed by the head unit 16, by the neutralizing charger 17. In this manner, the adsorption of the sheet S with respect to the drum 12 is reduced. The sheet S is discharged to the sheet discharge tray 37 through the transport guide 35 and the sheet discharge roller 36.

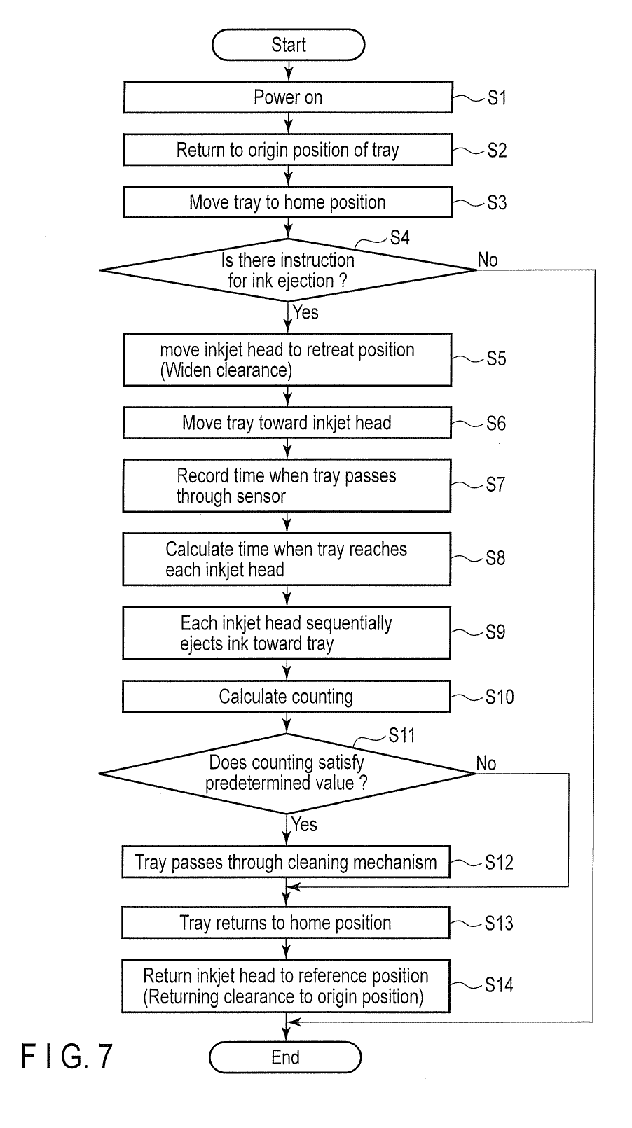

The inkjet printer 10 ejects ink from the inkjet heads 16a, 16b, 16c, and 16d periodically or at a predetermined time, in order to prevent nozzles of the inkjet heads 16a, 16b, 16c, and 16d from being clogged. Hereinafter, a sequence of an ink ejecting process will be described with reference to FIG. 7.

When the power switch 21 is turned on in Act Si in FIG. 7, the tray 60 returns to an origin position in Act S2. Returning to the origin position is performed, for example, by making the tray 60 be in contact with a stopper which is provided at a predetermined position. Alternatively, when a sensor 67 (shown in FIG. 1) for detecting a rotation angle, such as an encoder, is provided in the rotation axis 66 of the tray 60, it is possible to return to the origin position on the basis of a signal from the sensor 67.

In Act S3, the tray 60 moves to its home position. FIG. 1 shows a state where the tray 60 stops at its home position. In addition, its home position may match the origin position. When the tray moving motor 61 is a stepping motor, the tray 60 can be positioned on the basis of the number of pulses which drive the motor. When the tray moving motor 61 is a DC motor, the tray 60 can be positioned on the basis of the time after the tray 60 starts to move.

In Act S4, it is determined whether or not an ink ejection instruction is given by the CPU 80. If the ink ejection instruction is given, the process proceeds to Act S5. In Act S5, the head unit 16 is moved to the retreat position, shown in FIG. 3, by the head moving actuator 55. When the head unit 16 moves to the retreat position, the clearance C2 having a width through which the tray 60 can pass, is formed between the drum 12 and each inkjet heads 16a, 16b, 16c, and 16d. When the tray moving motor 61 rotates in Act S6, the tray 60 moves to a first direction (a direction shown by an arrow M1 in FIG. 2), toward the head unit 16.

When the sensor 64 detects that the tray 60 passes through, the time when the tray 60 passing through the sensor is recorded in Act S7, and the process proceeds to Act S8. In Act S8, an estimate time when the tray 60 reaches the inkjet heads 16a, 16b, 16c, and 16d, is calculated on the basis of the moving speed of the tray 60, the time when the tray 60 passes through the sensor, and the distance from the sensor 64 to the inkjet heads 16a, 16b, 16c, and 16d.

In Act S9, each inkjet head 16a, 16b, 16c, and 16d sequentially ejects ink according to the time when the tray 60 reaches each inkjet head 16a, 16b, 16c, and 16d. For example, as shown in FIG. 4, when the tray 60 reaches the fourth inkjet head 16d, the ink is ejected from the fourth inkjet head 16d toward the tray 60, by an ejection signal from the CPU 80. When the tray 60 reaches the third inkjet head 16c, the ink is ejected from the third inkjet head 16c toward the tray 60. When the tray 60 reaches the second inkjet head 16b, the ink is ejected from the second inkjet head 16b toward the tray 60. When the tray 60 reaches the first inkjet head 16a, the ink is ejected from the first inkjet head 16a toward the tray 60.

In this manner, the counts are made in Act S10 when the ink is ejected from inkjet heads 16a, 16b, 16c, and 16d. If the counts do not reach the predetermined numbers in Act S11, the process moves to Act S13.

When the counts reach the predetermined numbers in Act S11, the process proceeds to Act S12. In Act S12, the tray 60 reaches the cleaning mechanism 65 by further rotating in a first direction (a direction shown by the arrow M1 in FIG. 2). In the movement, the ink attached to the tray 60 is removed by the wiping member 75 when an ink reception position 60a of the tray 60 passes through the wiping member 75 while making contact with the wiping member 75.

It is possible to determine whether the tray 60 passed through the cleaning mechanism 65 based on the time after the tray 60 passed through the sensor 64. When the tray moving motor 61 is a stepping motor, it is possible to determine whether or not the tray 60 passed through the cleaning mechanism 65 on the basis of the number of pulses. When the sensor 67 for rotation angle, such as the encoder (shown in FIG. 1), is provided in the rotation axis 66 of the tray 60, it is possible to determine whether or not the tray 60 passed through the cleaning mechanism 65 on the basis of the signal from the sensor 67 for rotation angle.

After the tray 60 passed through the cleaning mechanism 65, the process proceeds to Act S13. In Act S13, due to a reverse rotation of the tray moving motor 61, the tray 60 moves in a second direction (a direction shown by the arrow M2 in FIG. 2), and returns to its home position Pₒ, shown in FIG. 3. Further, in Act S14, when the head unit 16 returns to the reference position shown in FIG. 1 by the head moving actuator 55, the tray return to the first clearance C1.

In this manner, the inkjet printer 10 according to the embodiment can receive ink which is ejected to prevent the nozzles from being clogged, using the tray 60 which moves independently from the drum 12. For this reason, since it is not necessary to provide a region for receiving the ink on the circumferential surface 26 of the drum 12, it is possible to use the entire circumference of the drum 12 as a region for holding the sheet S.

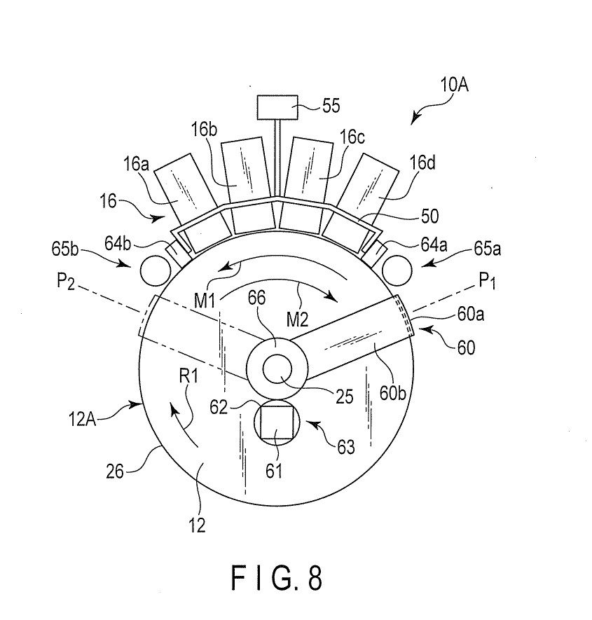

FIG. 8 shows a part of an inkjet printer 10A according to a second embodiment. A tray 60 according to the embodiment is made able to wait at a first home position P1 which is shown by a solid line and a second home position P2 shown by two dotted lines in FIG. 8. The first home position P1 is positioned at the rear side of the drum 12 in the rotation direction with respect to a head unit 16, similarly to the first embodiment. In contrast, the second home position P2 is set to be positioned in front side of the drum 12 in the rotation direction with respect to the head unit 16. A first sensor 64a and a first cleaning mechanism 65a are disposed between the first home position P1 and the head unit 16. A second sensor 64b and a second cleaning mechanism 65b are disposed between the second home position P2 and the head unit 16. The other configuration is the same as that of the inkjet printer 10 in the first embodiment.

In this inkjet printer 10A, if an ink ejecting instruction for preventing clogging of the nozzle is given, as in the first embodiment, a second clearance in which the tray 60 is inserted, is defined by moving the head unit 16 to a retreat position using a head moving actuator 55. In this state, the tray 60 is moved in the first direction M1 from the first home position P1 to the second home position P2, using the tray moving mechanism 63. Each inkjet head 16a, 16b, 16c, and 16d sequentially ejects ink to the tray 60 while the tray 60 is moving toward the second home position P2. Subsequently, the tray 60 stops at the second home position P2. Due to the returning of the head unit 16 to the reference position, a first clearance is defined between the circumference surface 26 of the drum 12 and the inkjet heads 16a, 16b, 16c, and 16d.

Further, when the next ink ejecting instruction is given, the head unit 16 moves to the retreat position again, using the head moving actuator 55. The tray 60 moves in the second direction M2 from the second home position P2 to the head unit 16. In addition, when the tray 60 passes through each inkjet head 16a, 16b, 16c, and 16d, the ink is sequentially ejected from each inkjet head 16a, 16b, 16c, and 16d to the tray 60. After that the tray 60 stops at the first home position P1. Further, the first clearance is defined between the circumferential surface 26 of the drum 12 and the inkjet heads 16a, 16b, 16c, and 16d, when the head unit 16 is returned to the reference position by the head moving actuator 55.

In the inkjet printer 10A according to the second embodiment, it is possible to make the head unit 16 wait at the first home position P1 or the second home position P2. In this case, since it is not necessary for the tray 60 to reciprocate to prevent clogging of the nozzle in each ink ejecting operation (one way is enough), it is possible to rapidly move to the image forming process. Since the other configurations and functions in the inkjet printer 10A are the same as those of the inkjet printer 10 in the first embodiment, the same portions will be denoted by the same reference numerals, and a description thereof will be omitted.

In addition, in the first and second embodiments, the head unit 16 is moved to the reference position and the retreat position using the actuator 55, with respect to the drum 12. However, in other embodiments, a second clearance for inserting the tray 60 may be defined between the drum 12 and the inkjet heads 16a, 16b, 16c, and 16d, by moving the drum 12 with respect to the head unit 16.

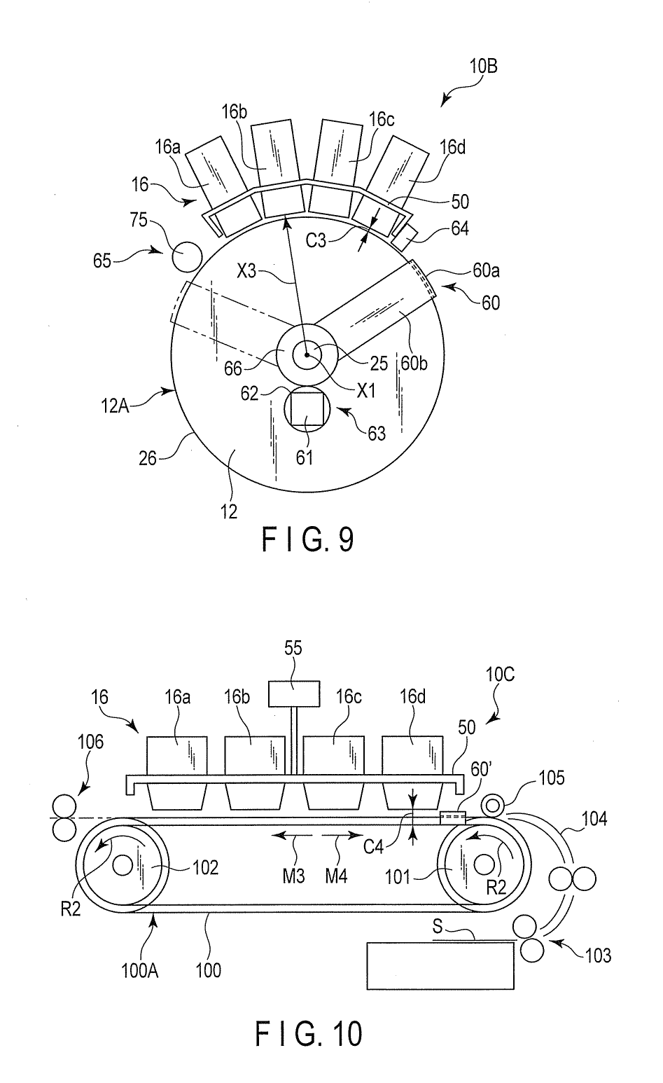

FIG. 9 shows an inkjet printer 10B according to a third embodiment. In the inkjet printer 10B, a clearance C3 for image forming has a width which can insert a tray 60. When ejecting ink in order to prevent clogging of the nozzle, it is possible to insert the tray 60 between a drum 12 and inkjet heads 16a, 16b, 16c, and 16d, using the clearance 03. For this reason, a distance X3 from X1 which is a rotation center of the drum 12 to a head unit 16, is set to be constant. The other configurations and functions of the inkjet printer 10B are the same as those of the inkjet printer 10 according to the first embodiment, both will be denoted by the same reference numeral at the same portions and a description thereof will be omitted.

FIG. 10 shows an inkjet printer 100 according to a fourth embodiment. The inkjet printer 100 has an endless device 100A formed of a belt 100. The belt 100 is extended between a first rotation body 101 and a second rotation body 102, and performs an endless rotation movement (circulation movement) in a direction shown by an arrow R2, using a driving mechanism which is not shown. A head unit 16 including inkjet heads 16a, 16b, 16c, and 16d, is disposed in a circumferential direction of the belt 100. A sheet S which is supplied from a sheet feeding mechanism 103 is supplied between the belt 100 and a charging roller 105 through a transporting path 104. The charging roller 105 applies electric charge to a dielectric layer which is provided on a circumferential surface of the belt 100, in order for an electro-static adsorption. On the sheet S, images are formed by the inkjet heads 16a, 16b, 16c, and 16d while being transported in a direction which is shown by the arrow R2, using the belt 100. The sheet S on which images are formed is discharged from a sheet transporting mechanism 106.

In the inkjet printer 10C according to the embodiment, a tray 60′ is movably disposed along the belt 100. The tray 60′ can be moved in a first direction shown by an arrow M3 and in a second direction shown by an arrow M4. The head unit 16 can be moved to a reference position and a retreat position, using a head moving actuator 55, similarly to the first embodiment. When an ink ejecting instruction is given, the head moving actuator 55 moves the head unit 16 from the reference position to the retreat position. In this manner, a clearance C4 through which the tray 60′ can pass is defined between the belt 100 and the inkjet heads 16a, 16b, 16c, and 16d. Since the inkjet printer 10C has the same configurations and functions as those of the inkjet printer 10 of the first embodiment, both will be denoted by the same reference numerals at the same portions and a description thereof will be omitted.

As described above, according to each inkjet printer of each embodiment, ink which is ejected for preventing clogging of nozzles can be received using a separate tray which is moving independently from an endless device (a drum or a belt). Since it is not necessary to provide a recessed portion for receiving ink in the endless device, it is possible to use the total circumferential surface of the endless device as a region where the sheet is held. Since the tray is moved periodically or at the predetermined time, independently from the endless device, it is possible to prevent waste ink which is attached to the tray, from being scattered around, even though the endless device rotates.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An inkjet printer comprising:
an endless device which has a circumferential surface which adsorbs a sheet, and rotates in a predetermined direction;
an inkjet head which is arranged to face the circumferential surface of the endless device, and defines a clearance between the inkjet head and the circumferential surface;
a tray which is relatively moved in a circumferential direction of the endless device, along the circumferential surface of the endless device, and is inserted to the clearance;
a tray moving mechanism which moves the tray to a position where the tray faces the inkjet head and a position where the tray does not face the inkjet head, independently from the endless device; and
a controller which gives an ink ejection instruction.

2. The inkjet printer according to claim 1,
wherein, the controller ejects ink from the inkjet head if the tray moves to a position corresponding to the inkjet head.

3. The inkjet printer according to claim 1,
wherein, the endless device is a drum in which the tray is configured to be moved around a rotation axis of the drum, and the clearance through which the tray can pass is defined between the circumferential surface of the drum and the inkjet head.

4. The inkjet printer according to claim 3,
wherein, the tray includes an ink reception unit which extends along an axial direction of the drum, and a pair of arms extending along the axial direction from both ends of the ink reception unit.

5. The inkjet printer according to claim 4,
wherein, the ink reception unit has a recessed portion which receives ink ejected from the inkjet head.

6. The inkjet printer according to claim 4,
wherein, the tray is attached to the same axis as the rotation axis of the drum with a posture in which the ink reception unit faces upward.

7. The inkjet printer according to claim 1,
wherein, the endless device is a belt, and the clearance through which the tray can pass is defined between the circumferential surface of the belt and the inkjet head.

8. The inkjet printer according to claim 1,
wherein, the inkjet head is movably disposed at a reference position where the first clearance is defined between the inkjet head and the circumferential surface of the endless device, and a retreat position where the second clearance, which is wider than the first clearance, is defined.

9. The inkjet printer according to claim 8, further comprising:
an actuator which moves the inkjet head to the reference position and the retreat position.

10. The inkjet printer according to claim 1, further comprising:
a cleaning mechanism which removes ink attached to the tray.

11. The inkjet printer according to claim 2,
wherein, the controller moves the tray to a position where the tray faces the inkjet head from a home position, using the tray moving mechanism, and allows the inkjet head to eject ink, and then returns the tray to the home position.

12. The inkjet printer according to claim 2,
wherein, the controller moves the tray to a second home position from a first home position through a position where the tray faces the inkjet head, using the tray moving mechanism, allows the inkjet head to eject ink while moving, and stops the tray at the second home position.

13. The inkjet printer according to claim 12, further comprising:
a first cleaning mechanism which is disposed between the first home position and the inkjet head, and removes ink attached to the tray; and
a second cleaning mechanism which is disposed between the second home position and the inkjet head, and removes ink attached to the tray.

14. The inkjet printer according to claim 4,
wherein, the inkjet head is a line head-type inkjet head which extends in an axial direction of the rotation axis of the drum, in which a width of the ink reception unit of the tray is larger than that of an ink ejection region of the inkjet head.

15. An ink ejection method of the inkjet printer comprising:
moving a tray in a circumferential direction of an endless device along a circumferential surface of the endless device;
inserting the tray to a clearance between the circumferential surface of the endless device and an inkjet head;
ejecting ink toward the tray from the inkjet head if the tray moves to a position facing the inkjet head; and
moving the tray to a home position from the clearance.

16. The method according to claim 15,
wherein, the tray is inserted to the clearance after the clearance for inserting the tray is defined, by moving the inkjet head in a direction separating from the circumferential surface of the endless device.

17. The method according to claim 15,
wherein, the tray is inserted to the clearance from the home position, and is returned to the home position after ink is ejected from the inkjet head.

18. The method according to claim 17,
wherein, ink which is attached to the tray is cleaned, after the ink is ejected from the inkjet head.

19. The method according to claim 15,
wherein, if an instruction for ejecting ink is given, the tray is inserted to the clearance from a first home position,
ink is ejected toward the tray from the inkjet head,
the tray is moved to a second home position and allowed to wait at the home position,
if the next instruction for ejecting ink is given, the tray is inserted to the clearance from the second home position,
ink is ejected toward the tray from the inkjet head, and
the tray is moved to the first home position and allowed to wait at the first home position.

20. The method according to claim 19,
wherein, if the tray is moved toward the first home position, the tray is cleaned in the vicinity of the first home position, and if the tray is moved toward the second home position, the tray is cleaned in the vicinity of the second home position.
